(19) United States
(12) Patent Application Publication
(10) Pub. No.: US 2024/0372193 A1
(43) Pub. Date: Nov. 7, 2024

(54) BATTERY WITH RECHARGEABLE ELECTROCHEMICAL ENERGY STORAGE ELEMENTS

(71) Applicant: VARTA Microbattery GmbH, Ellwangen Jagst (DE)

(72) Inventors: Andreas FAASS, Reimlingen (DE); David Zander, Noerdlingen (DE)

(21) Appl. No.: 18/646,801

(22) Filed: Apr. 26, 2024

(30) Foreign Application Priority Data
May 2, 2023 (EP) 23171071.6

(51) Int. Cl. H01M 50/213; H01M 10/42; H01M 50/249; H01M 50/512; H02J 7/00

(52) U.S. Cl. CPC H01M 50/213; H01M 10/425; H01M 50/512; H02J 7/0018; H01M 2010/4271; H01M 50/249

(57) ABSTRACT

A battery includes a housing, a positive pole, a negative pole, and a plurality of rechargeable electrochemical energy storage elements arranged in the housing. Each respective rechargeable electrochemical energy storage element is connected to a common circuit board and/or arranged in or on a common cell holder frame. A first subset of 24 to 42 rechargeable electrochemical energy storage elements of the plurality of rechargeable energy storage elements is connected in series and/or in parallel to form a primary pack. A second subset of 4 to 12 rechargeable electrochemical energy storage elements of the plurality of rechargeable energy storage elements is connected in series and/or in parallel to form a secondary pack. The primary pack has a positive output electrically connected to the positive terminal of the battery and a negative output electrically connected to the negative terminal of the battery. Battery management electronics can additionally be provided.

### CROSS REFERENCE TO RELATED APPLICATIONS

This application claims benefit to European Patent Application No. EP 23171071.6, filed on May 2, 2023, which is hereby incorporated by reference herein.

### FIELD

The present disclosure relates to a battery with a housing and a plurality of rechargeable electrochemical energy storage elements arranged therein. The battery is suitable for supplying power to the drive of an electric bicycle.

### BACKGROUND

Bicycles with electric motor assistance are widespread. The electric motor is primarily used as a starting aid and to support the crank movement. However, it is also possible for the electric motor to take over the drive completely. A battery (hereinafter referred to as a bicycle battery) is generally used to supply the electric motor with energy, which comprises a number of rechargeable (secondary) electrochemical energy storage elements, for example lithium-ion cells. Within the battery, the individual energy storage elements are generally electrically interconnected.

Such rechargeable batteries are also known as accumulators.

Chargers that are connected to a household power supply are generally used to charge bicycle batteries. Bicycle batteries are usually designed as interchangeable batteries, which can be connected to both the bicycle and the charger in a few simple steps using suitable plug connections.

Bicycle batteries or accumulators for bicycles often comprise an elongated housing that contains the energy storage elements. The plug required for the electrical contacting of the battery is usually inserted into an end cap of the housing during battery production. For example, DE 102021211776 B3 shows such an elongated accumulator in which a plug is screwed into an end face cap of the housing.

Conventional batteries or accumulators for bicycles are designed in such a way that they contain a number of energy storage elements of one type, which are connected in series and/or parallel depending on the requirements in order to achieve the desired electrical performance (power, capacity). However, this results in relatively little flexibility in the provision of the batteries, especially when it comes to batteries with a small number of energy storage elements. For example, if the length of the housing is designed so that twelve energy storage elements are arranged next to each other, these cells are usually connected in series (12S). If the number of rows is now increased from one row (1P) to two rows (2P), wherein these rows are connected in parallel to each other, this results in an elevation of the capacity by 100%. If the capacity is increased from two rows (2P) to three rows (3P), this results in an elevation of the capacity by a further 50% starting from 2P. With this procedure, it is therefore not possible to adapt the capacity in small steps to the respective requirements. This makes application-specific assembly more difficult.

For flexible adaptation to the respective requirements, WO 2018/141455 A1 proposes a bicycle battery that is equipped with several individual, exchangeable energy storage modules, and in particular also with several dummies. Depending on requirements, a corresponding number of modules and dummies can be selected by the user and the overall battery configured accordingly. However, this approach solves the need for greater flexibility in the configuration of the battery only in an unsatisfactory manner.

US 2022/0238943 A1 proposes a combination of an accumulator based on lithium-ion cells with a supercapacitor. These two separate energy storage devices, each provided with separate protective circuits, are combined in a common housing. The supercapacitor is used in particular as an additional energy source for higher acceleration. Such a combination of energy storage devices with different electrical properties results in a relatively poor integration factor, which has an unfavorable effect on the resulting weight and size of the entire arrangement. The costs are also elevated in an unfavorable way due to the increased mechanical effort (additional components for housing, cables, distribution sockets, cell holders, etc.).

### SUMMARY

In an embodiment, the present disclosure provides a battery that includes a housing, a positive pole, a negative pole, and a plurality of rechargeable electrochemical energy storage elements arranged in the housing. Each respective rechargeable electrochemical energy storage element is connected to a common circuit board and/or arranged in or on a common cell holder frame. A first subset of 24 to 42 rechargeable electrochemical energy storage elements of the plurality of rechargeable energy storage elements is connected in series and/or in parallel to form a primary pack. The primary pack has a first capacity and is configured to supply a first voltage. A second subset of 4 to 12 rechargeable electrochemical energy storage elements of the plurality of rechargeable energy storage elements is connected in series and/or in parallel to form a secondary pack. The secondary pack has a second capacity and is configured to supply a second voltage. The primary pack has a positive output electrically connected to the positive terminal of the battery and a negative output electrically connected to the negative terminal of the battery. In the battery, at least one of (i) the rechargeable electrochemical energy storage elements of the primary pack and the rechargeable electrochemical energy storage elements of the secondary pack can each be interconnected via battery management electronics such that a sum of the first capacity and the second capacity and/or a sum of the first voltage and the second voltage is a non-integer multiple of the first capacity, and/or (ii) each respective rechargeable electrochemical energy storage element of the second subset is assigned to one or more respective rechargeable electrochemical energy storage elements of the first subset and is configured to be connected thereto via battery management electronics such that the respective rechargeable electrochemical energy storage element can charge and/or discharge the one or more respective rechargeable electrochemical energy storage elements of the first subset assigned thereto independently of other rechargeable electrochemical energy storage elements of the first subset.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 Lateral view of a preferred embodiment of a battery according to the invention;

FIG. 2 Side view of a battery according to the invention with removed housing;

FIG. 3 Block diagram illustrating the operation of a battery according to the invention in a preferred embodiment; and

FIG. 4 Block diagram illustrating the operation of a battery according to the invention in a further preferred embodiment.

### DETAILED DESCRIPTION

Against this background, the present disclosure provides a battery that allows flexible assembly and that can be adapted to different requirements in terms of performance and capacity.

A battery according to the present disclosure comprises a housing and a plurality of rechargeable electrochemical energy storage elements arranged inside the housing. Furthermore, the battery is provided with a positive terminal and a negative terminal which can be tapped from outside the housing. First of all, this battery is characterized by the following features a. to d:
a. All energy storage elements are connected to a common circuit board and/or arranged in or on a common cell holder frame; and
b. a first part of the energy storage elements is combined by series and/or parallel connection to form a primary pack, wherein the primary pack has a first capacity and supplies a first voltage; and
c. a second part of the energy storage elements is combined by serial and/or parallel connection to form a secondary pack, wherein the secondary pack preferably has a second capacity and supplies a second voltage; and
d. the primary pack has a positive output that is electrically connected to the positive terminal of the battery, and the primary pack has a negative output that is electrically connected to the negative terminal of the battery.

The battery is further characterized by at least one of the following features e. and f:
e. The energy storage elements of the primary pack and the energy storage elements of the secondary pack can each be interconnected via battery management electronics in such a way that the capacities and/or voltages of the primary pack and secondary pack, in particular the capacities of the primary pack and secondary pack, add up;
and/or
f. each energy storage element of the secondary pack is assigned to one or more energy storage elements of the primary pack and can be connected to this or these via battery management electronics in such a way that the energy storage elements of the secondary pack can charge and/or discharge the respectively assigned energy storage element or elements of the primary pack independently of the other energy storage elements of the primary pack.

The aforementioned features e. and f. can be realized alternatively. The realization of feature e. is preferred. However, it may also be provided that features e. and f. are realized in combination with each other.

According to the aforementioned feature e., the energy storage elements of the primary pack are electrically interconnected or interconnectable. Independently from this, the energy storage elements of the secondary pack are electrically interconnected or can be interconnected. The primary pack and the secondary pack are two separate sub-battery packs. If necessary, further sub-battery packs, for example a tertiary pack, can also be provided. The sub-battery packs can in turn be interconnected via the battery management electronics so that their capacities and/or voltages are added together. All energy storage elements of the battery are integrated into a common mechanical structure, wherein all energy storage elements of the sub-packs are connected to the common circuit board or are alternatively or additionally arranged in or on the common cell holder frame.

It is preferred that in the embodiments according to the aforementioned features e. and f., the primary pack provides the system voltage of the battery and the energy storage elements of the secondary pack provide a supporting function for the primary pack.

The embodiment according to the aforementioned feature e. allows the usable capacity or performance of the overall battery to be improved by allowing the capacity and/or performance of the secondary pack to be added to the capacity and/or performance of the primary pack.

According to the embodiment in accordance with the aforementioned feature f., the energy storage elements of the secondary pack can be used for active balancing of the energy storage elements of the primary pack. In this case, the charge state of individual energy storage elements of the primary pack can be regulated as required by means of the energy storage elements of the secondary pack. When discharging the battery, the energy storage elements of the secondary pack can provide additional capacity for the energy storage elements of the primary pack at individual cell level if required in order to prevent deep discharge of individual energy storage elements of the primary pack. Active balancing ensures an even electrical charge distribution in all energy storage elements of the primary pack and protects against critical states of charge. Both a critical deep discharge and an overcharge can be counteracted.

According to the present disclosure, batteries can be provided that are optimally adapted to the respective requirements in terms of weight and size and in terms of the required capacity and performance.

In a preferred manner, the battery is characterized by at least one of the following additional features:
a. The energy storage elements of the secondary pack and/or the battery management electronics are designed for elevation of the first capacity provided by the energy storage elements of the primary pack.
b. The elevation of the capacity is a non-integer multiple of the first capacity provided by the energy storage cells of the primary pack.

Preferably, the aforementioned features a. and b. are realized in combination with each other.

A particular advantage is that the total capacity of the battery can be elevated to a non-integer multiple of the capacity of the primary pack. This is done without significantly affecting the integration factor of the overall battery, as the additional effort for the logical interconnection of the secondary pack is realized via the power distribution unit or the circuit board and/or via the battery management system. The fact that the number of energy storage elements in the primary pack and in the secondary pack can be freely selected allows a very high degree of flexibility in the configuration of the overall battery, which can be flexibly adapted according to the wishes of the manufacturer or the customer. For example, the capacity can be elevated by 25% without changing the overall voltage.

According to the above explanations, the battery is additionally or alternatively characterized by the following additional feature a:
a. The energy storage cells of the secondary pack and/or the battery management electronics are designed for active balancing of the energy storage cells of the primary pack.

In a preferred manner, at least one of the following additional features a. and b. is provided:
a. The battery comprises a battery management system that controls and/or regulates the active balancing and/or interconnection of the energy storage elements of the primary pack and the energy storage elements of the secondary pack for the purpose of elevation of the capacity and/or voltage provided by the energy storage cells of the primary pack.
b. The battery management system comprises first measuring and/or control and/or protection circuits for the primary pack and second measuring and/or control and/or protection circuits for the secondary pack and a microprocessor for controlling the circuits.

The entire battery is preferably controlled via the battery management system. This battery management system is implemented in particular on the aforementioned common circuit board, which is provided with the control circuits and measurement and protection circuits as well as the microprocessor. Preferably, the primary pack and the secondary pack are each assigned their own protection circuit.

Preferably, the battery is characterized by the following additional feature:
a. The secondary pack (1200) and the primary pack (1100) are connected in parallel.

The parallel connection of the secondary pack with the primary pack is expedient with regard to the described elevation of the capacity of the overall battery.

Preferably, the following additional feature is provided:
a. The battery comprises a voltage converter.
b. The voltage converter is designed to elevate the voltage of the secondary pack to the voltage of the primary pack.

By converting the voltage, the primary pack and the secondary pack can be brought to the same voltage level.

A bidirectional DC/DC converter is preferred.

In preferred embodiments, the battery provides a main voltage line and a secondary voltage line. In preferred embodiments of the battery in this respect, the battery is designed according to at least one of the following additional features:
a. The primary pack supplies a main voltage in a voltage range of 30 to 60 volts, preferably 48 volts.
b. The secondary pack supplies a secondary voltage in a voltage range of 8 to 15 volts, preferably 9 to 13 volts, preferably 12 volts.

In this configuration, the primary pack according to the aforementioned feature a. is primarily intended to provide electrical energy for an electric drive, for example the electric drive of a bicycle. The energy can be used to support starting or the crank movement, or the energy can be used to drive the electric drive alone. The auxiliary voltage can be used for other functions, in the case of a bicycle for example for the operation of lights and/or for heating the saddle and/or handlebars, for radar functions, for an airbag or similar.

With regard to the number and distribution of the individual energy storage elements in the primary pack and the secondary pack, the battery is characterized in preferred embodiments by at least one of the following additional features:
a. There are more electrochemical energy storage elements in the primary pack than in the secondary pack;
b. 24 to 42, preferably 24, electrochemical energy storage elements are arranged in the primary pack;
c. 4 to 12, preferably 6, electrochemical energy storage elements are arranged in the secondary pack.

Preferably, the aforementioned features a. and b. and preferably the aforementioned features a., b. and c. are realized in combination with each other.

These preferred numbers of energy storage elements within the battery are suitable for the realization of energy storage devices or accumulators for commercially available electric bicycles.

Preferably, only energy storage elements with the same nominal voltage and the same nominal capacity are used within the primary packs and within the secondary pack.

Furthermore, it is preferred that only energy storage elements with similar dimensions are used within the primary packs and within the secondary pack.

One example is lithium-ion cells in the 21700 format (70 mm height and 21 mm diameter).

In preferred embodiments of the battery, the interconnection of the energy storage elements within the primary pack and within the secondary pack is realized according to at least one of the following additional features:
a. The primary pack comprises two to four, preferably two or three, rows connected in parallel, each with 10 to 20, preferably 12 to 14, energy storage elements connected in series.
b. The secondary pack comprises one to three rows connected in parallel, each with 2 to 6, preferably 6, energy storage elements connected in series, wherein in the case of two or three rows the rows are connected in parallel.

Preferably, the aforementioned features a. and b. are realized in combination with each other.

In a preferred embodiment of a battery with a total of 30 energy storage elements, the primary pack may comprise, for example, 24 energy storage elements in a 12S2P configuration (two parallel rows of 12 energy storage elements connected in series with each other) and the secondary pack six energy storage elements in a 6S1P configuration (one row of six energy storage elements connected in series), wherein the primary pack and the secondary pack are also connected in parallel with each other.

In other embodiments, for example, a total of 45 energy storage elements may be provided in the battery, wherein 39 energy storage elements are comprised of the primary pack (in a 13S3P configuration with three parallel rows of 13 serially connected energy storage elements each) and six energy storage elements are comprised of the secondary pack (in a 6S1P configuration with one row of six serially connected energy storage elements).

In particular, batteries in these embodiments can be used to produce accumulators that are suitable for commercially available electric bicycles. Batteries with capacities in the range from 400 to 940 Wh, for example 500 Wh, can easily be realized this way.

All conventional secondary electrochemical energy storage elements can be used for the battery, wherein prismatic cells are also possible in addition to round cells. However, cylindrical round cells are preferred. The advantage of cylindrical round cells lies primarily in the fact that the round cells can be packed very tightly, wherein free spaces nevertheless remain between the round cells, which can be advantageous with regard to electrical and thermal insulation between the individual cells.

In preferred embodiments of the battery, the battery is characterized by at least one of the following additional features:
a. The energy storage elements are cylindrical round cells.
b. the energy storage elements are cells of type 21700.
c. the energy storage elements are lithium-ion energy storage elements.

Preferably, the aforementioned features a. and b. and, preferably, the aforementioned features a., b. and c. are realized in combination with one another.

In a preferred manner, the electrochemical energy storage elements of the battery are cylindrical round cells, which are arranged within the housing with their longitudinal axes aligned parallel in one plane and preferably in as close a packing as possible. The energy storage elements can also be arranged in several rows.

Type 21700 is the preferred form factor of the energy storage elements and refers to an outer diameter of 21 mm and a length of 70 mm.

Lithium-ion energy storage elements are preferred, as lithium-ion energy storage elements are characterized by a high energy density at a comparatively low weight.

Lithium-ion energy storage elements are based on the use of lithium, which can migrate back and forth between the electrodes of the element in the form of ions.

The negative electrode and the positive electrode of a lithium-ion energy storage element are generally formed by so-called composite electrodes, which comprise electrochemically inactive components as well as electrochemically active components.
1. In principle, all materials that can absorb and release lithium ions can be used as electrochemically active components (active materials) for secondary lithium-ion elements. For example, carbon-based particles such as graphitic carbon are used for the negative electrode. Active materials that can be used for the positive electrode include lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.
2. The active materials are generally applied as a layer on a ribbon-shaped current collector. The current collector is an electrochemically inactive component of the energy storage element. In particular, metallic foils are used as current collectors, which serve as carriers for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.
3. As electrolytes, lithium-ion energy storage elements usually comprise solutions of lithium salts such as lithium hexafluorophosphate (LiPF₆) in organic solvents (e.g. ethers and esters of carbonic acid).
4. In cylindrical round cells, the electrodes of the cell are generally arranged in the form of a coil, wherein at least one ribbon-shaped separator is arranged between ribbon-shaped electrodes. In other embodiments, in particular in prismatic energy storage elements, the electrodes can also be in stacked form.

In some preferred embodiments of the battery, the following additional feature is provided:
a. The energy storage elements of the secondary pack have different electrical properties to the energy storage elements of the primary pack.

Energy storage elements with different electrical properties can also be combined with each other in a battery according to the present disclosure. For example, it is possible to combine energy storage elements from different manufacturers, dimensions or different cell chemistries and to specifically utilize the respective properties of the different energy storage elements.

The energy storage elements of the primary pack can be lithium-ion cells, for example, and the energy storage elements of the secondary pack can be supercapacitors.

In preferred embodiments of the battery, the battery is characterized by at least one of the following additional features:
a. The battery is a rechargeable battery.
b. The battery is an accumulator for an electric vehicle.
c. The battery is an accumulator for an electric bicycle.

Preferably, the aforementioned features a. and b. and, preferably, the aforementioned features a. to c. are realized in combination with one another.

In a preferred manner, the battery is an exchangeable accumulator which can be connected to an electrical consumer and, if required, to a charging device for charging the accumulator in just a few simple steps.

The accumulator can basically be used for any electric vehicle, for example for an electric scooter, an electric wheelchair or other electric vehicles. Furthermore, the accumulator can be used, for example, to supply power to a robot, such as a service robot or the like. It can also be used as a voltage source for electric tools.

In preferred embodiments, the battery is an accumulator for an electric bicycle. The particular advantages of the battery are evident in the case of an electric bicycle, since the battery or accumulator can be assembled in a very advantageous manner during the manufacture of the bicycle.

With regard to advantageous embodiments of the housing of the battery, the battery is preferably characterized by at least one of the following additional features:
a. The housing comprises a metal tube.
b. The housing comprises an aluminum tube.
c. The housing comprises a metal tube with a rectangular cross-section.

Preferably, the aforementioned features a. and b. and, preferably, the aforementioned features a. to c. are realized in combination with one another.

The advantage of a metal housing is that it provides stability to the battery. Such stability is regularly required in a battery for an electric bicycle, for example, for safety reasons. Aluminum is suitable as it allows the weight of the resulting battery to be kept relatively low. In addition, aluminum has the further advantage that it has good heat dissipation properties, which are advantageous for the battery.

An elongated housing with a rectangular cross-section is suitable, wherein the housing is preferably formed by a metal tube with a rectangular cross-section and two end caps, preferably made of plastic. On the one hand, such a housing shape ensures high stability and, on the other hand, offers advantageous possibilities for arranging the energy storage elements within the housing. The elongated shape of the accumulator furthermore makes the battery suitable for use as a bicycle accumulator, since such an elongated housing can be advantageously attached to or in the region of the frame of a bicycle.

In a preferred manner, the electrochemical energy storage elements are held in a cell holder frame made of plastic or are arranged in or on it. Such a frame holds and fixes the energy storage elements within the battery and stabilizes the arrangement of the energy storage elements. The plastic material of the cell holder ensures a relatively low weight of the battery, so that such a cell holder is suitable for use of the battery as a bicycle accumulator. Suitable plastic materials are known to the skilled person.

Overall, the present disclosure provides for highly flexible assembly of batteries depending on the desired application.

In the battery, the capacity in particular can be flexibly expanded, wherein the secondary pack provides the additional capacity. On the other hand, the secondary pack can be used for active balancing of the energy storage elements of the primary pack, wherein the energy of the secondary pack can be transferred to or withdrawn from individual energy storage elements of the primary pack. Various combinations and possible applications can be realized.

The particular advantage lies in that various battery requirements can be met very precisely. By combining the primary pack and secondary pack or, if necessary, further sub-packs, the required properties, for example with regard to the drive technology, can be flexibly fulfilled, so that the battery can be adapted very well to different requirements. This also results in advantages for the end user, for example for the bicycle customer, as the weight and volume of the battery are optimized in the very well adapted battery.

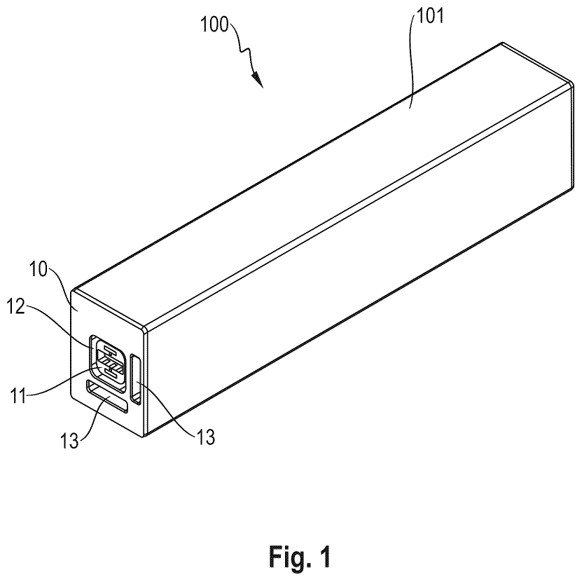

FIG. 1 shows an external view of a preferred embodiment of a battery 100. The housing of the battery 100 is formed by a metallic tube 101, in particular an aluminum tube, wherein the tube has a rectangular cross-section.

Inside the tube 101, lithium-ion cells in the form of cylindrical round cells are arranged as electrochemical energy storage elements. The energy storage elements are electrically connected via a battery management electronics on a printed circuit board which, together with a microprocessor, forms the battery management system.

The front end face of the battery 100 is closed by a terminal end cap 10. A connector 11 is integrated into the end cap 10, via which the power and signals of the interconnected energy storage elements are led to the outside. The end cap 10 is an injection-molded plastic part. The plug 11 is surrounded by a circumferential depression 12. The depression 12 serves as a guide for the counterpart of the plug to be plugged in.

On the inner side of the end cap 10, which is not visible here, the plug is connected to the energy storage elements, for example directly via the printed circuit board.

Two channel-shaped depressions 13 are also provided on the outer surface of the end cap 10. These depressions 13 form retaining and/or guiding elements for mounting the battery 100, for example on the frame of an electric bicycle. In particular, the depressions 13 can serve as positioning means for attaching the battery 100 to the bicycle.

The end face of the housing opposite the end cap 10 can also be closed by a plastic injection-molded part as a further end cap. Alternatively, the ends can also be made of aluminum or another metal.

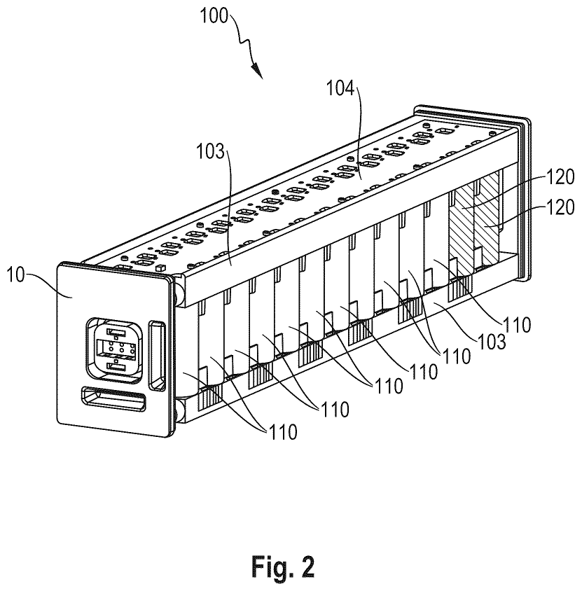

FIG. 2 shows a side view of the battery 100 of FIG. 1 with the housing removed. The cylindrical round cells 110 and 120 contained inside the battery can be seen. In this exemplary embodiment shown, a total of 39 cylindrical round cells 110, 120 are provided. The primary pack is formed by three parallel-connected rows of eleven round cells 110 (configuration 11S3P) connected in series with each other. The secondary pack is formed by six serially interconnected round cells 120 (configuration 6S1P). In preferred embodiments, the primary pack and the secondary pack are connected in parallel. The energy storage elements 120 combined in the secondary pack have a supporting function for the primary pack.

In other embodiments, it may alternatively or additionally be provided that the energy storage elements 120 are used for actively balancing the energy storage elements 110 of the primary pack.

In other, preferred embodiments, for example, two parallel-connected rows of 12 serially connected round cells (primary pack configuration: 12S2P) plus one row of six serially connected round cells (secondary pack configuration: 6S1P) are provided. By connecting the primary pack and secondary pack in parallel, their capacities are added together, resulting in a total battery pack with the configuration 12S2.5P.

The individual round cells 110, 120 stand upright and are arranged with parallel alignment of the longitudinal axes in close packing. The round cells 110, 120 are held by an upper and lower frame made of plastic (cell holder 103) and can be glued to the cell holder for fixation. The round cells 110, 120 are electrically connected via the battery management electronics, which are arranged on the circuit board 104.

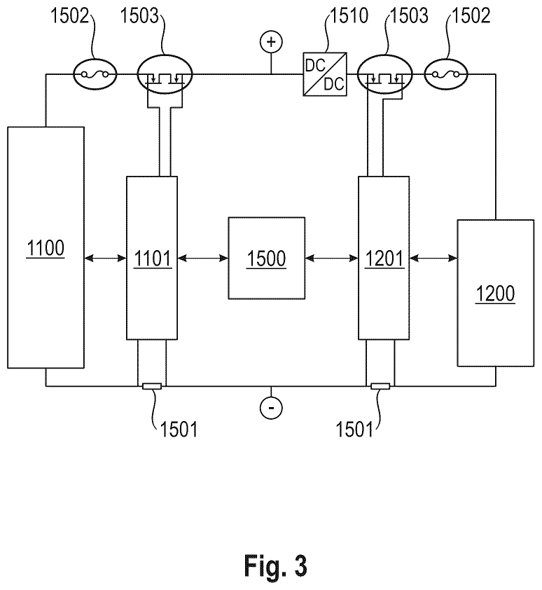

FIG. 3 shows a block diagram illustrating the connection of the capacity of the secondary pack to the capacity of the primary pack. The primary pack 1100, which comprises, for example, 24 energy storage elements, is shown on the left of the block diagram. The energy storage elements can, for example, be arranged in two rows connected in parallel, wherein the two rows each comprise twelve cylindrical round cells (e.g. lithium-ion cells) connected in series with one another (configuration 12S2P). The secondary pack 1200 is shown on the right of the block diagram, which consists of six serially interconnected energy storage elements, for example (configuration 6S1P). The interconnection of the energy storage elements of the secondary pack 1200 and the interconnection of the energy storage elements of the primary pack 1100 is carried out via a battery management system comprising first measuring and/or control and/or protection circuits 1101 for the primary pack 1100 and second measuring and/or control and/or protection circuits 1201 for the secondary pack 1200, a microprocessor 1500 for controlling the circuits 1101 and 1201 and measuring resistors 1501.

In this example, the capacity of the secondary pack 1200 is connected to the capacity of the primary pack 1100 via a bidirectional DC/DC converter 1510.

If, for example, a customer of the battery manufacturer wants to elevate the capacity of a battery equipped with energy storage elements in the 12S2P configuration by 25% without changing the overall voltage, this can be done by connecting the secondary pack (6S1P configuration). The hybrid battery pack then consists of the primary pack in the 12S2P configuration (with a total of 24 energy storage elements) and the 6S1P secondary pack, and has a voltage and a capacity equivalent to a 12S2.5P battery. Conventional batteries with such a configuration do not exist.

Mechanically, the primary and secondary packs are fully integrated into the housing of the battery. The subdivision into primary pack and secondary pack results solely from the electrical interconnection of the individual energy storage elements. In this way, an optimized battery can be provided that can be optimally adapted to the respective requirements in terms of capacity and performance.

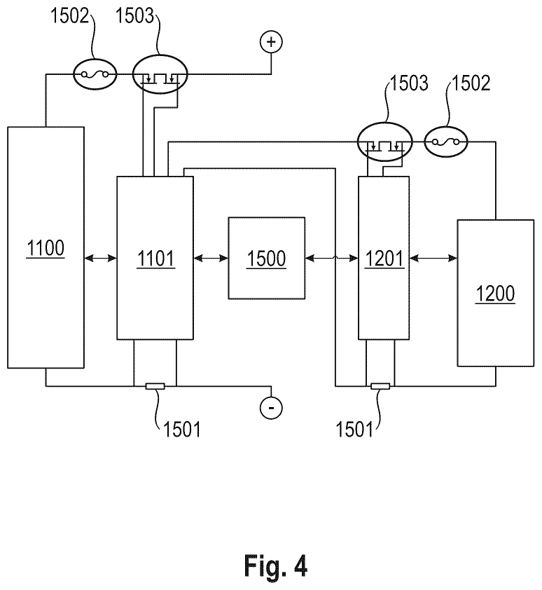

FIG. 4 shows an embodiment in which the energy storage elements of the secondary pack 1200 are used for active balancing of the energy storage elements of the primary pack 1100. Comparable to the block diagram of FIG. 3, the energy storage elements of the primary pack 1100 and the energy storage elements of the secondary pack 1200 are interconnected via a battery management system comprising first measurement and/or control and/or protection circuits 1101 for the primary pack 1100, second measurement and/or control and/or protection circuits 1201 for the secondary pack 1200 and a microprocessor 1500 for controlling the circuits 1101 and 1201. The interconnection takes place on a common circuit board on which the aforementioned components of the battery management system (in addition to other components such as the fuse 1502 or the control circuits 1503) are arranged.

In contrast to the embodiment according to FIG. 3, in this example embodiment the battery management electronics 1101 of the primary pack 1100 is configured to integrate an active balancing function that can utilize the individual energy storage elements of the secondary pack 1200 to balance the energy storage elements of the primary pack in order to avoid a critical deep discharge and/or an overcharge of the individual energy storage elements of the primary pack 1100. Balancing can elevate the lifetime of the energy storage elements and improve their performance.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements. e.g., A. any subset from the listed elements. e.g., A and B. or the entire list of elements A. B and C.

1. A battery, comprising:
a housing;
a positive pole;
a negative pole; and
a plurality of rechargeable electrochemical energy storage elements arranged in the housing, each respective rechargeable electrochemical energy storage element being connected to a common circuit board and/or arranged in or on a common cell holder frame,
wherein a first subset of 24 to 42 rechargeable electrochemical energy storage elements of the plurality of rechargeable energy storage elements is connected in series and/or in parallel to form a primary pack, the primary pack having a first capacity and being configured to supply a first voltage; and
wherein a second subset of 4 to 12 rechargeable electrochemical energy storage elements of the plurality of rechargeable energy storage elements is connected in series and/or in parallel to form a secondary pack, the secondary pack having a second capacity and being configured to supply a second voltage; and
wherein the primary pack has a positive output electrically connected to the positive terminal of the battery and a negative output electrically connected to the negative terminal of the battery, and
wherein at least one of:
the rechargeable electrochemical energy storage elements of the primary pack and the rechargeable electrochemical energy storage elements of the secondary pack can each be interconnected via battery management electronics such that a sum of the first capacity and the second capacity and/or a sum of the first voltage and the second voltage is a non-integer multiple of the first capacity, and/or
each respective rechargeable electrochemical energy storage element of the second subset is assigned to one or more respective rechargeable electrochemical energy storage elements of the first subset and is configured to be connected thereto via battery management electronics such that the respective rechargeable electrochemical energy storage element can charge and/or discharge the one or more respective rechargeable electrochemical energy storage elements of the first subset assigned thereto independently of other rechargeable electrochemical energy storage elements of the first subset.

2. The battery according to claim 1, wherein the second subset of rechargeable electrochemical energy storage elements and/or the battery management electronics are configured to elevate the first capacity.

3. The battery according to claim 1, second subset of rechargeable electrochemical energy storage cells and/or the battery management electronics are configured to provide active balancing of the first subset of rechargeable electrochemical energy storage cells.

4. The battery according to claim 1, further comprising a battery management system, wherein at least one of:
the battery management system is configured to control and/or regulate active balancing and/or interconnection of the first subset of rechargeable electrochemical energy storage elements and the second subset of rechargeable electrochemical energy storage elements to elevate of the first capacity and/or the first voltage, or
the battery management system comprises first circuits for the primary pack and second circuits for the secondary pack and a microprocessor configured to control the first and second circuits.

5. The battery according to claim 1, wherein the secondary pack and the primary pack are connected in parallel.

6. The battery according to claim 1, wherein at least one of:
the battery further comprises a voltage converter; or
the voltage converter is configured to elevate the second voltage to the first voltage.

7. The battery according to claim 1, wherein the first voltage is in a voltage range of 30 to 60 volts, and
wherein the second voltage is in a voltage range of 8 to 15 volts.

8. The battery according to claim 1, wherein at least one of:
the first subset includes 24 rechargeable electrochemical energy storage elements, or
the second subset includes 6 rechargeable electrochemical energy storage elements.

9. The battery according to claim 1, wherein at least one of:
the primary pack comprises two to four rows, connected in parallel, of 10 to 20 rechargeable electrochemical energy storage elements connected in series, or
the secondary pack comprises one to three rows, connected in parallel, of 2 to 6 rechargeable electrochemical energy storage elements connected in series.

10. The battery according to claim 1, wherein at least one of:
the plurality of rechargeable electrochemical energy storage elements are cylindrical round cells,
the plurality of rechargeable electrochemical energy storage elements are cells of type 21700, or
the plurality of rechargeable electrochemical energy storage elements are lithium-ion energy storage elements.

11. The battery according to claim 1, wherein the rechargeable electrochemical energy storage elements of the secondary pack have different electrical properties than the rechargeable electrochemical energy storage elements of the primary pack.

12. The battery according to claim 1, wherein at least one of:
the battery is an exchangeable accumulator,
the battery is an accumulator for an electric vehicle, or
the battery is an accumulator for an electric bicycle.
